(19) United States
(12) Patent Application Publication
(10) Pub. No.: US 2024/0235802 A9
(43) Pub. Date: Jul. 11, 2024

(54) UTILIZING UNUSED FREQUENCY DIVISION DUPLEX UPLINK FOR TIME DIVISION DUPLEX OPERATIONS IN WIRELESS NETWORKS

(71) Applicant: T-MOBILE INNOVATIONS LLC, Overland Park, KS (US)

(72) Inventors: Nagi A. Mansour; Akin Ozozlu

(21) Appl. No.: 17/970,967

(22) Filed: Oct. 21, 2022

(51) Int. Cl. H04L 5/16

(52) U.S. Cl. CPC H04L 5/16

(57) ABSTRACT

Methods, media, and systems are provided for utilizing unused frequency division duplex (FDD) uplink for time division duplex (TDD) operation in a wireless network. For example, an antenna array comprising one or more antenna elements provides a coverage area (e.g., on at least one TDD carrier and at least one FDD carrier). At least a portion of an available FDD uplink is identified. Based on identifying at least the portion of the available FDD uplink, the identified available FDD uplink can be assigned for a TDD operation. The TDD operation can correspond to the at least one TDD carrier. The TDD operation may include receiving uplink control information from a user device via a TDD uplink that is utilizing the available FDD uplink. In some embodiments, the TDD operation may include transmitting a TDD downlink to the user device utilizing the available FDD uplink.

### SUMMARY

A high-level overview of various aspects of the invention are provided here for that reason, to provide an overview of the disclosure and to introduce a selection of concepts that are further described in the detailed-description section below. This summary is not intended to identify key features or essential features of the claimed subject matter, nor is it intended to be used as an aid in isolation to determine the scope of the claimed subject matter. The present disclosure is directed, in part, to systems and methods for utilizing unused frequency division duplex (FDD) uplink for time division duplex (TDD) operation in a wireless network, substantially as shown in and/or described in connection with at least one of the figures, and as set forth more completely in the claims.

In aspects set forth herein, and at a high level, the technology described herein relates to identifying at least a portion of an available FDD uplink to utilize for one or more TDD operations (e.g., via a TDD uplink or a TDD downlink). In some embodiments, the available FDD uplink may be identified based on a number of user devices within a coverage area, a channel bandwidth, a number of subcarriers, a number of resource blocks, another type of FDD uplink availability identifier, or one or more combinations thereof. Based on identifying at least the portion of the available FDD uplink, the identified available FDD uplink can be assigned for a TDD operation. The TDD operation may include receiving uplink control information from a user device via a TDD uplink that is utilizing the available FDD uplink. In some embodiments, the TDD operation may include transmitting a TDD downlink to the user device utilizing the available FDD uplink.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, wherein:

FIG. 1 depicts an example operating environment for utilizing unused frequency division duplex (FDD) uplink for time division duplex (TDD) operation in a wireless network, in accordance with aspects herein;

FIG. 2 depicts an example environment associated with an example FDD mode, in accordance with aspects herein;

FIG. 3 depicts an example environment in response to utilizing the unused FDD uplink for the TDD operation, in accordance with aspects herein;

FIG. 4 illustrates an example in method for utilizing the unused FDD uplink for a TDD downlink, in accordance with aspects herein;

FIG. 5 illustrates an example in method for utilizing the unused FDD uplink for a TDD uplink, in accordance with aspects herein; and

FIG. 6 depicts an exemplary computing environment suitable for use in implementations of the present disclosure, in accordance with aspects herein.

### DETAILED DESCRIPTION

The subject matter of embodiments of the invention is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout this disclosure, several acronyms and shorthand notations are employed to aid the understanding of certain concepts pertaining to the associated system and services. These acronyms and shorthand notations are intended to help provide an easy methodology of communicating the ideas expressed herein and are not meant to limit the scope of embodiments described in the present disclosure. The following is a list of these acronyms:

| | |
|---|---|
| 3G | Third-Generation Wireless Technology |
| 4G | Fourth-Generation Cellular Communication System |
| 5G | Fifth-Generation Cellular Communication System |
| ARFCN | Absolute Radio Frequency Channel Number |
| CA | Carrier Aggregation |
| CD-ROM | Compact Disk Read Only Memory |
| CDMA | Code Division Multiple Access |
| CLLI | Common Language Location Identifier |
| CSI | Channel State Information |
| eNB | Evolved Node B |
| FDD | Frequency Division Duplex |
| gNB | Next Generation Node B |
| GPRS | General Packet Radio Service |
| GSM | Global System for Mobile communications |
| DVD | Digital Versatile Discs |
| EEPROM | Electrically Erasable Programmable Read Only Memory |
| E-UTRA | Evolved Universal Terrestrial Radio Access |
| FD-MIMO | Full-Dimension Multiple-Input Multiple-Output |
| IoT | Internet of Things |
| LTE | Long Term Evolution |
| MAC | Media Access Control |
| MID | Management Instrumentation and Discovery |
| MIMO | Multiple-Input Multiple-Output |
| MU-MIMO | Multi-User Multiple-Input Multiple-Output |
| NR | New Radio |
| OFDM | Orthogonal Frequency-Division Multiplexing |
| OTDOA | Observed Time Difference of Arrival |
| PC | Personal Computer |
| PDA | Personal Digital Assistant |
| PDCCH | Physical Downlink Control Channel |
| PLMN | Public Land Mobile Network |
| PUCCH | Physical Uplink Control Channel |
| QoS | Quality of Service |
| RAM | Random Access Memory |
| RF | Radio-Frequency |
| ROM | Read Only Memory |
| RSRP | Reference Transmission Receive Power |
| RSRQ | Reference Transmission Receive Quality |
| RSSI | Received Signal Strength Indicator |
| SIM | Subscriber Identity Module |
| SINR | Signal-to-Interference and Noise Ratio |
| TDD | Time Division Duplex |
| TDMA | Time Division Multiple Access |
| UICC | Universal Integrated Circuit Card |
| VLAN | Virtual Local-Area-Network |
| VoNR | Voice over NR |
| VoLTE | Voice over LTE |

In addition, words such as “a” and “an,” unless otherwise indicated to the contrary, may also include the plural as well as the singular. Thus, for example, the constraint of “a feature” is satisfied where one or more features are present. Furthermore, the term “or” includes the conjunctive, the disjunctive, and both (a or b thus includes either a or b, as well as a and b).

Further, the term “some” may refer to “one or more.” Additionally, an element in the singular may refer to “one or more.” The term “combination” (e.g., a combination thereof, combinations thereof) may refer to, for example, “at least one of A, B, or C”; “at least one of A, B, and C”; “at least two of A, B, or C” (e.g., AA, AB, AC, BB, BA, BC, CC, CA, CB); “each of A, B, and C”; and may include multiples of A, multiples of B, or multiples of C (e.g., CCABB, ACBB, ABB, etc.). Other combinations may include more or less than three options associated with the A, B, and C examples.

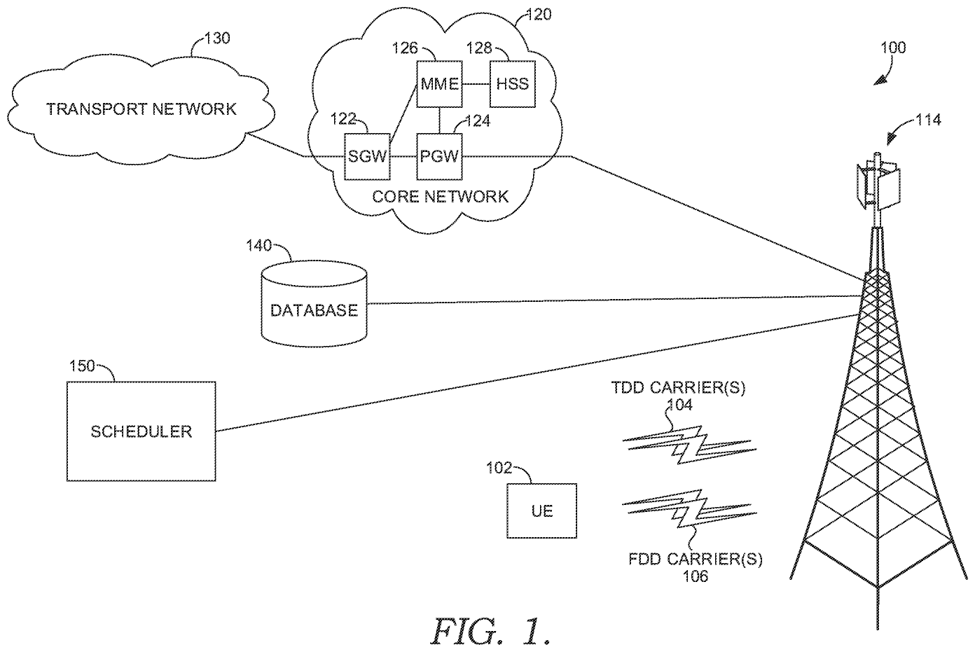

Additionally, a “user device,” as used herein, is a device that has the capability of using a wireless communications network, and may also be referred to as a “computing device,” “mobile device,” “user equipment,” “wireless communication device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using a wireless communication. A user device may be, in an embodiment, similar to user device 102 described herein with respect to FIG. 1. A user device may also be, in another embodiment, similar to user device 800, described herein with respect to FIG. 8.

A user device may additionally include internet-of-things devices, such as one or more of the following: a sensor, controller (e.g., a lighting controller, a thermostat), appliances (e.g., a smart refrigerator, a smart air conditioner, a smart alarm system), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or a combination thereof.

In aspects, a user device discussed herein may be configured to communicate using one or more of 4G (e.g., LTE), 5G, 6G, another generation communication system, or a combination thereof. In some aspects, the user device has a radio that connects with a 4G cell site but is not capable of connecting with a higher generation communication system. In some aspects, the user device has components to establish a 5G connection with a 5G gNB, and to be served according to 5G over that connection. In some aspects, the user device may be an E-UTRAN New Radio—Dual Connectivity (ENDC) device. ENDC allows a user device to connect to an LTE eNB that acts as a master node and a 5G gNB that acts as a secondary node. As such, in these aspects, the ENDC device may access both LTE and 5G simultaneously, and in some cases, on the same spectrum band.

Wireless telecommunication services (e.g., the transfer of information without the use of an electrical conductor as the transferring medium) may be provided by one or more telecommunication network providers. Wireless telecommunication services may include, but are not limited to, the transfer of information via radio waves (e.g., Bluetooth®), satellite communication, infrared communication, microwave communication, Wi-Fi, millimeter wave communication, and mobile communication. Embodiments of the present technology may be used with different wireless telecommunication technologies or standards, including, but not limited to, CDMA 1×Advanced, GPRS, Ev-DO, TDMA, GSM, WiMax technology, LTE, LTE Advanced, other technologies and standards, or a combination thereof.

A network providing the wireless telecommunication services may be a telecommunication network(s), or a portion thereof. A telecommunication network might include an array of devices or components (e.g., one or more cell sites). The network can include multiple networks, and the network can be a network of networks. In embodiments, the network is a core network, such as an evolved packet core, which may include at least one mobility management entity, at least one serving gateway, and at least one Packet Data Network gateway. The mobility management entity may manage non-access stratum (e.g., control plane) functions such as mobility, authentication, and bearer management for other devices associated with the evolved packet core.

In some aspects, a network can connect one or more user devices to a corresponding immediate service provider for services such as 5G and LTE, for example. In aspects, the network provides wireless telecommunication services comprising one or more of a voice service, a message service (e.g., SMS messages, MMS messages, instant messaging messages, an EMS service messages), a data service, other types of wireless telecommunication services, or a combination thereof, to user devices or corresponding users that are registered or subscribed to a telecommunication service provider to utilize the one or more services. The network can comprise any communication network providing voice, message, or data service(s), such as, for example, a 1× circuit voice, a 3G network (e.g., CDMA, CDMA2000, WCDMA, GSM, UMTS), a 4G network (WiMAX, LTE, HSDPA), a 5G network, a 6G network, another generation network, or a combination thereof.

Components of the network, such as terminals, links, and nodes (as well as other components), can provide connectivity in various implementations. For example, components of the network may include core network nodes, relay devices, integrated access and backhaul nodes, macro eNBs, small cell eNBs, gNBs, relay cell sites, other network components, or a combination thereof. The network may interface with one or more cell sites through one or more wired or wireless backhauls. As such, the one or more cell sites may communicate to devices via the network or directly. Furthermore, user devices can utilize the network to communicate with other devices (e.g., a user device(s), a server(s), etc.) through the one or more cell sites.

As used herein, the term “cell site” (used for providing UEs with access to the telecommunication services) generally refers to one or more cellular base stations, nodes, RRUs control components, and the like (configured to provide a wireless interface between a wired network and a wirelessly connected user device). A cell site may comprise one or more nodes (e.g., eNB, gNB, and the like) that are configured to communicate with user devices. In some aspects, the cell site may include one or more band pass filters, radios, antenna arrays, power amplifiers, transmitters/receivers, digital signal processors, control electronics, GPS equipment, and the like. An eNB or gNB corresponding to the cell site may comprise one or more of a macro base station, a small cell or femtocell base station, a relay base station, a combination thereof, and so forth. In aspects, the cell site may be configured as FD-MIMO, massive MIMO, MU-MIMO, cooperative MIMO, 3G, 4G, 5G, another generation communication system, or a combination thereof. In addition, the cell site may operate in an extremely high frequency region of the spectrum (e.g., from 30 GHz to 300 GHz), also known as the millimeter band.

Embodiments of the technology described herein may be embodied as, among other things, a method, system, or computer-program product. Accordingly, the embodiments may take the form of a hardware embodiment, or an embodiment combining software and hardware. An embodiment that takes the form of a computer-program product can include computer-useable instructions embodied on one or more computer-readable media.

Computer-readable media include both volatile and nonvolatile media, removable and nonremovable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions—including data structures and program modules—in a modulated data signal (e.g., a modulated data signal referring to a propagated signal that has one or more of its characteristics set or changed to encode information in the signal). Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

The technology disclosed herein generally relates to a spectrum usage technique. For example, radio access technology generally relates to connection methods between devices and a wireless network (e.g., Wi-Fi, Bluetooth, 2G, 3G, 4G, 5G, 6G, or other wireless networks). In accordance with the radio access technology, an access node can provide one or more cells, each cell defined on a respective radio-frequency carrier, which could be FDD with separate frequency bands for downlink transmissions from a cell site to a user device and uplink transmissions from a user device to a cell site (such that both uplink and downlink transmissions can occur simultaneously), or TDD with a single frequency band multiplexed over time between downlink and uplink transmissions (such that the uplink and downlink transmissions occur separately).

User devices can have hardware configurations supporting network telecommunications over a carrier bandwidth or one or more of a plurality of carrier bandwidths. In some embodiments, a user device is configured to operate over one or more portions (e.g., a sub-band or bandwidth part) or all of a carrier bandwidth. In some embodiments, carrier transmitting signal waveforms can comprise a plurality of subcarriers by using, for example, multi-carrier modulation techniques including OFDM or discrete Fourier transformation spread OFDM. In some embodiments, a carrier can be divided into one or more bandwidth parts having the same or different numerologies (e.g., a subcarrier spacing and cyclic prefix).

On the downlink and uplink channels, an air interface of each cell can be configured to define physical resources for wirelessly carrying information between the access node and devices. For instance, the air interface can be divided over time into frames, each divided into subframes and timeslots, and the radio-frequency carrier could be divided over frequency into subcarriers, which could be grouped within each timeslot to define physical resource blocks in which the subcarriers can be modulated to carry data. One or more cell sites can be configured to coordinate use of uplink and downlink air interface resources.

By way of background, prior methods and systems have had drawbacks associated with the utilization of TDD and FDD network configurations. For example, prior methods and systems have not utilized available FDD uplink channels as a resource for TDD operations. As such, user devices attempting to use particular uplink carrier frequencies to access and utilize a wireless network have experienced lower qualities of service. As an example, if a user device attempts to increase throughput associated with a data rate, TDD resources available to all user devices within a cell were previously limited and resulted in latencies. Accordingly, it would be beneficial for a more balanced TDD and FDD network configuration.

The systems and methods provided herein can alleviate the problems discussed above. For example, the technology disclosed herein reduces latency, improves the balancing of one or more TDD and FDD network configurations, and enhances user device quality of service. In addition, the technology disclosed herein can improve antenna throughput and performance based on the balancing techniques for the one or more TDD and FDD network configurations. For example, an embodiment disclosed herein provides for a system that identifies and utilizes unused FDD uplink for TDD operation in a wireless telecommunication network. The system comprises an antenna array comprising one or more antenna elements, one or more processors, and computer memory storing computer-usable instructions that, when executed by the one or more processors, perform operations. The operations comprise providing a coverage area, via the antenna array, on at least one TDD carrier and at least one FDD carrier. The operations further comprise identifying at least a portion of an available FDD uplink corresponding to the at least one FDD carrier. At least the portion of the available FDD uplink identified is assigned for a TDD operation corresponding to the at least one TDD carrier.

In another embodiment, a method that identifies and utilizes unused FDD uplink for TDD operation in a wireless telecommunication network. The method comprises identifying at least a portion of an available FDD uplink corresponding to an FDD carrier and a wireless telecommunication network associated with a coverage area. The method further comprises assigning at least the portion of the available FDD uplink identified for a TDD uplink. The method receives, via the TDD uplink utilizing at least the portion of the available FDD uplink, a transmission from a user device within the coverage area.

Another embodiment includes a method that also identifies and utilizes unused FDD uplink for TDD operation in a wireless telecommunication network. At least a portion of an available FDD uplink, corresponding to an FDD carrier and a wireless telecommunication network associated with a coverage area, is identified. At least the portion of the available FDD uplink identified is assigned for a TDD downlink. The TDD downlink assigned at least the portion of the available FDD uplink is transmitted to a user device within the coverage area.

Turning now to FIG. 1, example environment 100 comprises user device 102 configured to receive coverage via one or more TDD carriers 104, one or more FDD carriers 106, or one or more combinations thereof, provided by cell site 114. Example environment 100 also comprises core network 120, transport network 130, database 140, and scheduler 150. Example environment 100 is but one example of a suitable environment for utilizing unused frequency division duplex (FDD) uplink for time division duplex (TDD) operation in a wireless network, and is not intended to suggest any limitation as to the scope of use or functionality of the invention. Neither should the environment 100 be interpreted as having any dependency or requirement relating to any one or combination of components illustrated.

User device 102 may wirelessly communicate via one or more wireless telecommunication services provided by one or more cell sites 114. Cell site 114 can provide a coverage area for supporting communication signals according to one or more radio access technologies and corresponding to the one or more user devices 102. In embodiments, the one or more user devices 102 can be stationary, mobile, or one or more combinations thereof at different times. In embodiments, the one or more user devices 102 may have different capabilities. The one or more user devices 102 can communicate with various types of devices, such as other user devices, database 140, the cell site 114, core network 120, transport network 130, scheduler 150, network equipment (e.g., core network nodes, relay devices, integrated access and backhaul nodes, other network equipment), another type of device, or one or more combinations thereof.

The one or more user devices 102 may include a unit, a station, a terminal, or a client, for example. The one or more user devices 102 may also include a wireless local loop station, an IoT device, an Internet of Everything device, a machine type communication device, an evolved or enhanced machine type communication device, another type of user device, or one or more combinations thereof. The machine type communication device or the evolved or enhanced machine type communication device may include, for example, one or more robots, drones, remote devices, sensors, meters, monitors, location tags, etc., that may communicate with a cell site, another device (e.g., remote device), or some other entity. In some embodiments, one or more user devices 102 may be implemented in various objects such as appliances, or vehicles, meters, and other objects. In some embodiments, the one or more user devices 102 may sometimes act as a relay as well as the cell site 114 and the network equipment including macro eNBs or gNBs, small cell eNBs or gNBs, or relay base stations, for example.

The one or more user devices 102 and the cell site 114 may wirelessly communicate with one another over one or more carriers (e.g., a set of radio frequency spectrum resources having a defined physical layer structure for supporting communication links). For example, a carrier may include a portion of a radio frequency spectrum band (e.g., a bandwidth part) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. Example environment 100 may support communication with a user device 102 using carrier aggregation or multi-carrier operation.

In embodiments, cell site 114 can be configured to operate according to 3G, 4G, 5G, another generation communication system, or one or more combinations thereof. For instance, the cell site 114 could be an LTE eNB or a 5G NR gNB, among other possibilities. In embodiments, cell site 114 may be equipped with multiple antennas, which may be used to employ techniques such as transmit diversity, receive diversity, MIMO communications (e.g., FD-MIMO, massive MIMO, MU-MIMO, cooperative MIMO), beamforming, other techniques, or one or more combinations thereof. In some embodiments, one or more cell site antennas or antenna arrays may be co-located at an antenna assembly, such as an antenna tower. In some examples, antennas or antenna arrays associated with cell site 114 may be located in diverse geographic locations. In some embodiments, the cell site 114 is configured to transmit millimeter waves. In some aspects, one or more nodes corresponding to cell site 114 may comprise one or more macro cells, one or more small cells, one or more relay base stations, one or more repeaters, one or more femtocells, other types of cells, or one or more combinations thereof.

As depicted in example environment 100, the cell site 114 is a node on core network 120 (e.g., an evolved packet core network, next generation core network or another network including components supporting an applicable radio access technology) providing connectivity with at least one transport network 130, such as the Internet. Core network 120 comprises serving gateway (SGW) 122, packet data network gateway (PGW) 124, mobility management entity (MME) 126, and home subscriber server (HSS) 128. Cell site 114 may have an interface with the SGW 122, the SGW 122 may have an interface with the PGW 124, and the PGW 124 may provide connectivity with the transport network 130. Further, the cell site 114 may have an interface with the MME 126, and the MME 126 may have an interface with the SGW 122 and the HSS 128.

In embodiments, the SGW and PGW may cooperatively provide user-plane connectivity between the cell site 114 and the transport network 130, to enable a user device (e.g., user device 102) served by the cell site 114 to engage in communication on the transport network 130. The MME 126 may operate as a controller to carry out operations, such as coordinating user device attachment and setup of user-plane bearers. Further, the HSS 128 may have access to database 140 having user device capabilities and service profile data, and the HSS 128 can work with the MME 126 to facilitate user device authentication. In other embodiments, the HSS 128 may include a data store having the user device capabilities and service profile data.

In embodiments, the network 120 may include one or more telecommunication networks (or a portion of a network or a network of networks), such as local area networks, wide area networks, the Internet, other remote networks, or a combination thereof to transfer data between the user device 102 and the network 120. In some embodiments, the network 120 may comprise one or more wired or wireless programmable devices, such as cellular networks (e.g., a Global System for Mobile communications), IEEE 802.11 networks, other suitable radio-based networks, or a combination thereof. The network 120 may also include one or more network devices, such as servers, routers, network switches, other network hardware devices configured to transport data over the network 120, or a combination thereof.

Transport network 130 may comprise a cloud service that includes one or more computing devices in one or more geographic locations connected via one or more networks. For example, the transport network 130 may include one or more servers or computers acting as servers in datacenters at one or more geographic locations where the servers communicate using one or more Internet connections. A communication channel between the transport network 130 and the database 140 (e.g., one or more servers or computers acting as servers in one or more datacenters) or the user device 102 may include one or more communication mechanisms for electronic communication. For example, the communication channel may incorporate one or more of local area networks, wide area networks, virtual private networks, cellular networks (e.g., long-term evolution networks), wireless fidelity Wi-Fi networks, Bluetooth, Near Field Communication, other network types for transferring data, or one or more combinations thereof.

In embodiments, the air interface access may be scheduled by the scheduler 150. The scheduler 150 is a node or device that schedules traffic in a wireless telecommunication network, including uplink communications and downlink communications (e.g., scheduling information including a grant, synchronization information, timing information, other control information, or one or more combinations thereof) corresponding to the user device 102 and the cell site 114. The scheduler may be the cell site 114 or one or more user devices 102 in a peer-to-peer network, one or more user devices 102 in a mesh network, one or more user devices 102 in a relay configuration, or one or more combinations thereof. The scheduler 150 allocates resources for communication among some or all user devices 102 and equipment within a coverage area or cell of the cell site 114. In embodiments, the scheduler 150 may schedule, assign, reconfigure, and release resources for one or more user devices 102. As such, the scheduler 150 allocates resources to the one or more user devices 102 for scheduled communication.

Upon identifying at least a portion of available FDD uplink corresponding to the one or more FDD carriers 106 in example environment 100, wherein the cell site 114 provides a coverage area on the one or more TDD carriers 104 and the one or more FDD carriers 106, the scheduler 150 can assign or allocate the available FDD uplink for one or more TDD operations corresponding to the one or more TDD carriers 104. For example, the scheduler 150 (e.g., the cell site 114) may allocate one or more resource elements, which correspond to the one or more FDD carriers 106 and the available FDD uplink, to carry downlink control information via TDD downlink configuration. As another example, the scheduler 150 can receive one or more transmissions from one or more user devices within the coverage area via a TDD uplink (e.g., corresponding to the one or more TDD carriers 104) that utilizes at least the portion of the available FDD uplink (e.g., corresponding to the one or more FDD carriers 106).

In embodiments, one or more downlink channels (e.g., PDCCH) may be carried to one or more user devices 102 based on the TDD configuration utilizing the available FDD uplink. For example, the PDCCH may carry downlink control information, such as, for example, power control commands (e.g., one or more open-loop power control parameters, one or more closed-loop power control parameters, other power control parameters, or one or more combinations thereof), scheduling information, a grant, an assignment of one or more resource elements for downlink and uplink transmissions, another type of downlink control information, or one or more combinations thereof. The PDCCH may, in some embodiments, also carry hybrid automatic repeat request feedback transmissions, such as an acknowledgment or a negative acknowledgment. Hybrid automatic repeat request is a technique that checks the integrity of packet transmissions at the receiving side for accuracy (e.g., via an integrity checking mechanism, such as a checksum or a cyclic redundancy check).

The scheduler 150 (e.g., the cell site 114) may also allocate one or more resource elements (e.g., resource elements in a control or data portion of a slot of a subframe) to carry other downlink information-via a TDD mode using the available FDD uplink-including a demodulation reference signal, a phase-tracking reference signal, a channel state information reference signal, a synchronization signal block, another type of downlink information, or one or more combinations thereof. In embodiments, the synchronization signal block includes a physical broadcast control channel, which also includes a master information block that has system information, such as a subcarrier spacing, a system frame number, a configuration of a PDCCH control resource set, a cell barred indicator, a cell reselection indicator, a raster offset, a search space for a system information block, other types of system information, or one or more combinations thereof. Other system information transmitted via the TDD mode using the available FDD uplink may include a random access search space, a paging search space, downlink configuration information, an uplink configuration information, or one or more combinations thereof.

In uplink transmissions via the TDD mode using the available FDD uplink, the user device 102 can utilize one or more resource elements to carry uplink control information (e.g., channel state information, an acknowledgment, a negative acknowledgment, a scheduling request). For example, the user device 102 may be configured with one or more downlink component carriers and one or more uplink component carriers according to a carrier aggregation configuration. Continuing the example, carrier aggregation may be used with both FDD and TDD component carriers. In other embodiments, the user device 102 is configured with one or more downlink component carriers of the one or more TDD carriers 104. In embodiments, one or more user devices 102 can have hardware configurations supporting communications over a particular carrier bandwidth or one of a set of carrier bandwidths.

The one or more TDD carriers 104 and the one or more FDD carriers 106, in some embodiments, may be identified by a respective ARFCN (e.g., an E-UTRA ARFCN). In some embodiments, TDD and FDD modes may be detected from one or more synchronization signals. In some embodiments, the TDD and FDD modes may be detected from a secondary synchronization signal that is a specific physical layer signal used for radio frame synchronization. Accordingly, at least a portion of available FDD uplink corresponding to the one or more FDD carriers 106 can be identified in some embodiments based at least in part on one or more of the ARFCN, synchronization signals, the secondary synchronization signal, another type of signal, or one or more combinations thereof.

Cell site 114 may configure an air interface on the one or more TDD carriers 104 to have a particular uplink-downlink configuration that establishes a particular percentage of time that the carrier will be downlink versus uplink, thereby defining downlink and uplink bandwidths of the carrier (e.g., by multiplying the percentage by the carrier bandwidth). Further, based on the available FDD uplink identified, the cell site 114 can establish the particular percentage of time that the one or more TDD carriers 104 will be downlink versus uplink. In a TDD mode, uplink and downlink transmissions occur at different time periods using the same frequency band. For example, a subset of the subframes (e.g., downlink subframes) in a radio frame may be used for downlink transmissions, and another subset of the subframes (e.g., uplink subframes) in the radio frame may be used for uplink transmissions.

In some embodiments of the TDD configuration that utilizes the available FDD uplink, in various outdoor and macro coverage deployments of less than 3 GHz TDD and FDD implementations, subcarrier spacing may occur with 15 kHz, for example over 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Further, for various deployments transmitting with mmWave components at a TDD of 28 GHz, subcarrier spacing may occur with 120 kHz over a 500 MHz bandwidth.

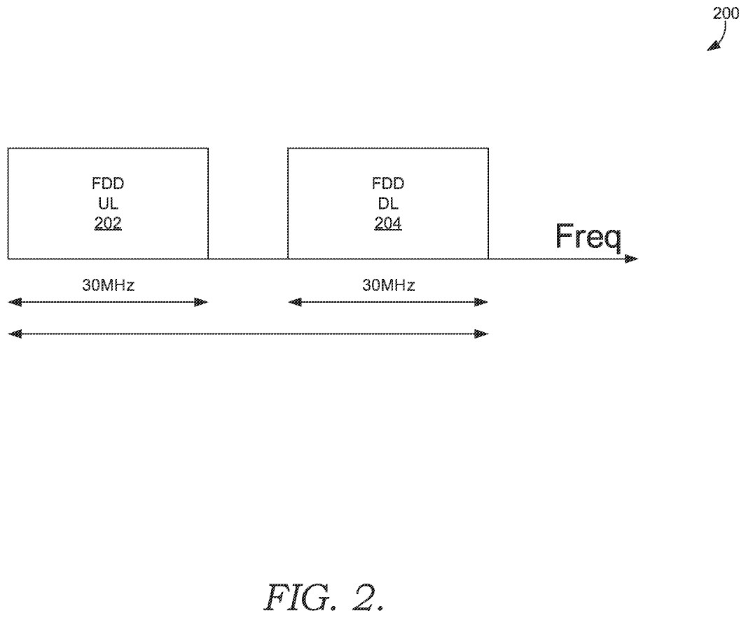

Turning to FIG. 2, an example environment 200 is illustrated for an example FDD mode. For example, the FDD uplink 202 and the FDD downlink 204 may correspond to a frequency band of 1900 MHz. Continuing the example, the FDD uplink 202 and the FDD downlink 204 may each correspond to 30 MHz. The FDD uplink 202 and the FDD downlink 204 are determined by frequency allocation and have a frequency separation. A user device may receive downlink control information associated with the FDD uplink 202 and the FDD downlink 204. In embodiments, available FDD uplink 202 (or portions thereof) can be identified based on user devices in the coverage area being engaged in uplink transmissions (e.g., quantified in terms of rise over thermal).

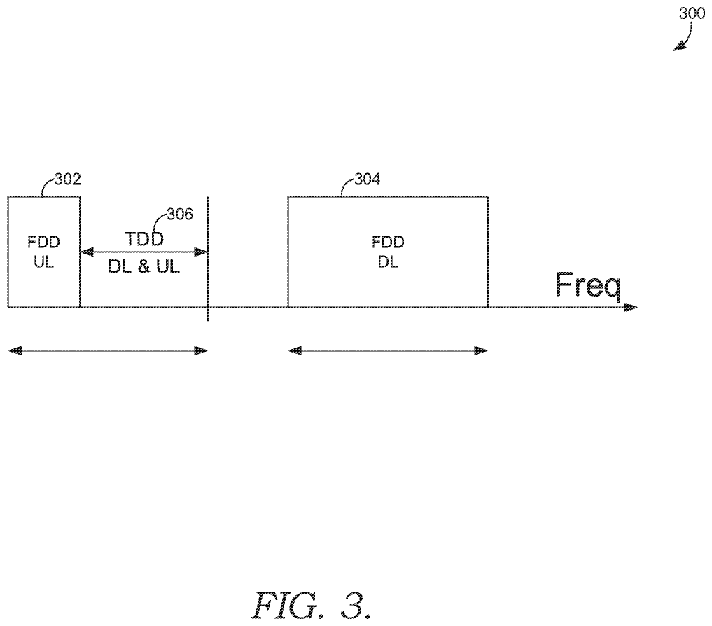

Turning to FIG. 3, example environment 300 is associated with utilizing the unused FDD uplink for one or more TDD operations. For example, a portion of FDD uplink 202 of FIG. 2 is determined to be available (e.g., based on user devices in the coverage area being engaged in uplink transmissions). As such, the portion of the FDD uplink that is available is utilized in TDD uplink and downlink operations 306. Further, the FDD uplink 202 of FIG. 2 is reduced to FDD uplink 302, and FDD downlink 304 remains the same as FDD downlink 204 of FIG. 2.

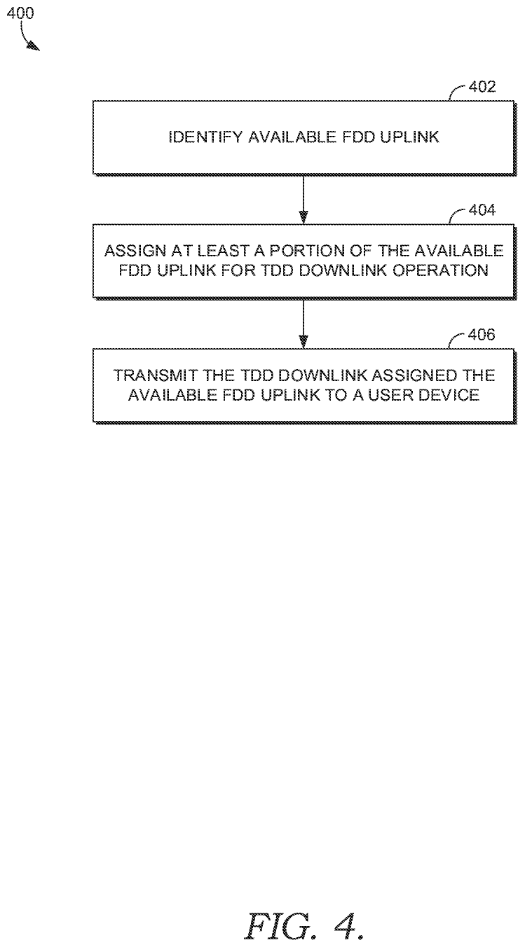

Turning to FIG. 4, example method 400 for utilizing the unused FDD uplink for a TDD downlink is illustrated. At 402, the method comprises identifying at least a portion of an available FDD uplink corresponding to an FDD carrier and a wireless telecommunication network associated with a coverage area. In embodiments, at least the portion of available FDD uplink (e.g., corresponding to the one or more FDD carriers 106 of FIG. 1) can be identified in some embodiments based at least in part on one or more of the ARFCN, synchronization signals, the secondary synchronization signal, another type of signal, or one or more combinations thereof. In some embodiments, the at least the portion of available FDD uplink can be identified based at least in part on one or more user devices in the coverage area being engaged in uplink transmissions quantified in terms of rise over thermal-a ratio of total received power to thermal noise power. The total received power includes the power of all received signals, including intended transmissions, interfering transmissions, and other noise. In some embodiments, the available FDD uplink can be identified based on one or more user device rise over thermal levels and a total rise over thermal level corresponding to a particular coverage area. In some embodiments, the available FDD uplink can be identified based on one or more user device's assigned transmission power level and the total rise over thermal level corresponding to the particular coverage area. In some embodiments, the available FDD uplink can be identified based on FDD capability information of the user devices within the coverage area, TDD capability information of the user devices within the coverage area, or one or more combinations thereof.

At 404, the method comprises assigning at least the portion of the available FDD uplink identified for a TDD downlink. In some embodiments, a second portion of the available FDD uplink is assigned for a TDD uplink. In some embodiments, the second portion of the available FDD uplink is assigned for a second TDD downlink. In some embodiments, the second portion of the available FDD uplink is assigned for the second TDD downlink and a third portion of the available FDD uplink is assigned for the TDD uplink. In some embodiments, based on assigning at least the portion of the available FDD uplink identified for the TDD downlink, the method further comprises allocating one or more resource elements to carry downlink information (via the TDD downlink assigned at least the portion of the available FDD uplink) to a user device within a corresponding coverage area.

In some embodiments, the available FDD uplink identified corresponds to a frequency band of 1900 MHz. In some embodiments, the available FDD uplink identified corresponds to LTE band 1. In some embodiments, the available FDD uplink corresponds to a primary carrier associated with a majority of the user devices within the coverage area. In some embodiments, the available FDD uplink corresponds to a secondary carrier associated with a majority of the user devices within the coverage area. In some embodiments, the available FDD uplink identified corresponds to a half-duplex FDD mode of operation. In some embodiments, a TDD carrier, associated with the TDD downlink assigned at least the portion of the available FDD uplink, is a primary carrier of the user device. In some embodiments, a TDD carrier, associated with the TDD downlink assigned at least the portion of the available FDD uplink, is a secondary carrier of the user device.

At 406, the method comprises transmitting the TDD downlink assigned at least the portion of the available FDD uplink to a user device within the coverage area. In some embodiments, the method further comprises transmitting scheduling information to the user device via the TDD downlink assigned at least the portion of the available FDD uplink. In embodiments where the second portion of the available FDD uplink identified for a TDD uplink, the method may further comprise receiving, via the TDD uplink utilizing the second portion of the available FDD uplink, a transmission from the user device within the coverage area.

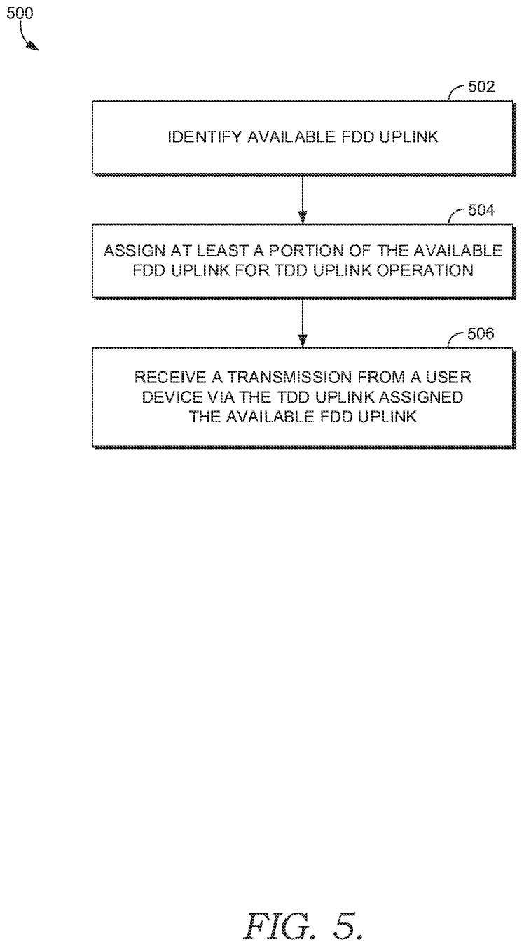

Turning to FIG. 5, example method 500 is depicted for utilizing the unused FDD uplink for a TDD uplink is illustrated. At 502, the method comprises identifying at least a portion of an available FDD uplink corresponding to an FDD carrier and a wireless telecommunication network associated with a coverage area. At 504, the method comprises assigning at least the portion of the available FDD uplink identified for a TDD uplink. At 506, the method comprises receiving, via the TDD uplink utilizing at least the portion of the available FDD uplink, a transmission from a user device within the coverage area. In some embodiments, the transmission, from the user device received via the TDD uplink utilizing at least the portion of the available FDD uplink, comprises channel state information, and wherein the user device is configured for FDD and TDD carrier aggregation, and wherein the wireless telecommunication network provides a 5G network. Further, uplink control information may be received (e.g., received by a cell site) from a user device within the coverage area, wherein the control information is received via a TDD uplink corresponding to the at least one TDD carrier, and wherein the TDD uplink utilizes at least the portion of the available FDD uplink. In some embodiments, the method may comprise receiving a feedback message, from a user device within the coverage area, via a TDD uplink corresponding to the at least one TDD carrier, wherein the TDD uplink utilizes at least the portion of the available FDD uplink.

In some embodiments, the method may also comprise identifying a second portion of the available FDD uplink and assigning the second portion of the available FDD uplink identified for a TDD downlink. Continuing the example, the method may also comprise transmitting the TDD downlink assigned the second portion of the available FDD uplink to the user device. In aspects, both the TDD uplink utilizing at least the portion of the available FDD uplink and the TDD downlink assigned the second portion of the available FDD uplink correspond to a TDD carrier. The TDD carrier can be a secondary carrier of the user device.

### Example User Device

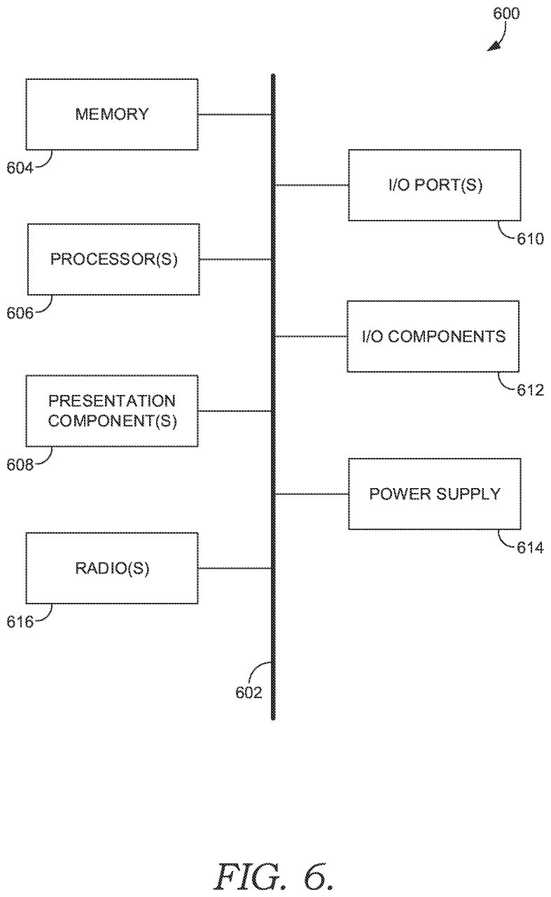

Having described the example embodiments discussed above of the presently disclosed technology, an example operating environment of an example user device (e.g., user device 102 of FIG. 1) is described below with respect to FIG. 6. User device 600 is but one example of a suitable computing environment, and is not intended to suggest any particular limitation as to the scope of use or functionality of the technology disclosed. Neither should user device 600 be interpreted as having any dependency or requirement relating to any particular component illustrated, or a particular combination of the components illustrated in FIG. 6.

As illustrated in FIG. 6, example user device 600 includes a bus 602 that directly or indirectly couples the following devices: memory 604, one or more processors 606, one or more presentation components 608, one or more input/output (I/O) ports 610, one or more I/O components 612, a power supply 614, and one or more radios 616.

Bus 602 represents what may be one or more busses (such as an address bus, data bus, or combination thereof). Although the various blocks of FIG. 6 are shown with lines for the sake of clarity, in reality, these blocks represent logical, not necessarily actual, components. For example, one may consider a presentation component, such as a display device, to be an I/O component. Also, processors have memory. Accordingly, FIG. 6 is merely illustrative of an exemplary user device that can be used in connection with one or more embodiments of the technology disclosed herein.

User device 600 can include a variety of computer-readable media. Computer-readable media can be any available media that can be accessed by user device 600 and may include both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by user device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. One or more combinations of any of the above should also be included within the scope of computer-readable media.

Memory 604 includes computer storage media in the form of volatile and/or nonvolatile memory. The memory 604 may be removable, non-removable, or a combination thereof. Example hardware devices of memory 604 may include solid-state memory, hard drives, optical-disc drives, other hardware, or one or more combinations thereof. As indicated above, the computer storage media of the memory 604 may include RAM, Dynamic RAM, ROM, EEPROM, flash memory or other memory technology, CD-ROM, a cache memory, DVDs or other optical disk storage, magnetic cassettes, magnetic tape, magnetic disk storage or other magnetic storage devices, a short-term memory unit, a long-term memory unit, any other medium which can be used to store the desired information and which can be accessed by user device 600, or one or more combinations thereof.

The one or more processors 606 of user device 600 can read data from various entities, such as the memory 604 or the I/O component(s) 612. The one or more processors 606 may include, for example, one or more microprocessors, one or more CPUs, a digital signal processor, one or more cores, a host processor, a controller, a chip, a microchip, one or more circuits, a logic unit, an integrated circuit (IC), an application-specific IC (ASIC), any other suitable multi-purpose or specific processor or controller, or one or more combinations thereof. In addition, the one or more processors 606 can execute instructions, for example, of an operating system of the user device 600 or of one or more suitable applications.

The one or more presentation components 608 can present data indications via user device 600, another user device, or a combination thereof. Example presentation components 608 may include a display device, speaker, printing component, vibrating component, another type of presentation component, or one or more combinations thereof. In some embodiments, the one or more presentation components 608 may comprise one or more applications or services on a user device, across a plurality of user devices, or in the cloud. The one or more presentation components 608 can generate user interface features, such as graphics, buttons, sliders, menus, lists, prompts, charts, audio prompts, alerts, vibrations, pop-ups, notification-bar or status-bar items, in-app notifications, other user interface features, or one or more combinations thereof. For example, the one or more presentation components 608 can present a visualization that compares a plurality of inspections of one or more cores of a central processing unit and a visualization of each task of each of the plurality of inspections.

The one or more I/O ports 610 allow user device 600 to be logically coupled to other devices, including the one or more I/O components 612, some of which may be built in. Example I/O components 612 can include a microphone, joystick, game pad, satellite dish, scanner, printer, wireless device, and the like. The one or more I/O components 612 may, for example, provide a natural user interface (NUI) that processes air gestures, voice, or other physiological inputs generated by a user. In some instances, the inputs the user generates may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with the one or more presentation components 608 on the user device 600. In some embodiments, the user device 600 may be equipped with one or more imaging devices, such as one or more depth cameras, one or more stereoscopic cameras, one or more infrared cameras, one or more RGB cameras, another type of imaging device, or one or more combinations thereof, (e.g., for gesture detection and recognition). Additionally, the user device 600 may, additionally or alternatively, be equipped with accelerometers or gyroscopes that enable detection of motion. In some embodiments, the output of the accelerometers or gyroscopes may be provided to the one or more presentation components 608 of the user device 600 to render immersive augmented reality or virtual reality.

The power supply 614 of user device 600 may be implemented as one or more batteries or another power source for providing power to components of the user device 600. In embodiments, the power supply 614 can include an external power supply, such as an AC adapter or a powered docking cradle that supplements or recharges the one or more batteries. In aspects, the external power supply can override one or more batteries or another type of power source located within the user device 600.

Some embodiments of user device 600 may include one or more radios 616 (or similar wireless communication components). The one or more radios 616 can transmit, receive, or both transmit and receive signals for wireless communications. In embodiments, the user device 600 may be a wireless terminal adapted to receive communications and media over various wireless networks. User device 600 may communicate using the one or more radios 616 via one or more wireless protocols, such as code division multiple access (“CDMA”), global system for mobiles (“GSM”), time division multiple access (“TDMA”), another type of wireless protocol, or one or more combinations thereof. In embodiments, the wireless communications may include one or more short-range connections (e.g., a Wi-Fi® connection, a Bluetooth connection, a near-field communication connection), a long-range connection (e.g., CDMA, GPRS, GSM, TDMA, 602.16 protocols), or one or more combinations thereof. In some embodiments, the one or more radios 616 may facilitate communication via radio frequency signals, frames, blocks, transmission streams, packets, messages, data items, data, another type of wireless communication, or one or more combinations thereof. The one or more radios 616 may be capable of transmitting, receiving, or both transmitting and receiving wireless communications via mmWaves, FD-MIMO, massive MIMO, 3G, 4G, 5G, 6G, another type of Generation, 802.11 protocols and techniques, another type of wireless communication, or one or more combinations thereof.

Having identified various components utilized herein, it should be understood that any number of components and arrangements may be employed to achieve the desired functionality within the scope of the present disclosure. For example, the components in the embodiments depicted in the figures are shown with lines for the sake of conceptual clarity. Other arrangements of these and other components may also be implemented. For example, although some components are depicted as single components, many of the elements described herein may be implemented as discrete or distributed components or in conjunction with other components, and in any suitable combination and location. Some elements may be omitted altogether. Moreover, various functions described herein as being performed by one or more entities may be carried out by hardware, firmware, and/or software. For instance, various functions may be carried out by a processor executing instructions stored in memory. As such, other arrangements and elements (for example, machines, interfaces, functions, orders, and groupings of functions, and the like) can be used in addition to, or instead of, those shown.

Embodiments of the present disclosure have been described with the intent to be illustrative rather than restrictive. Embodiments described in the paragraphs above may be combined with one or more of the specifically described alternatives. In particular, an embodiment that is claimed may contain a reference, in the alternative, to more than one other embodiment. The embodiment that is claimed may specify a further limitation of the subject matter claimed. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and subcombinations are of utility and may be employed without reference to other features and subcombinations and are contemplated within the scope of the claims

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

The invention claimed is:

1. A system for utilizing unused frequency division duplex (FDD) uplink for time division duplex (TDD) operation in a wireless telecommunication network, the system comprising:
an antenna array comprising one or more antenna elements;
one or more processors; and
computer memory storing computer-usable instructions that, when executed by the one or more processors, perform operations comprising:
providing a coverage area, via the antenna array, on at least one TDD carrier and at least one FDD carrier;
identifying at least a portion of an available FDD uplink corresponding to the at least one FDD carrier; and
assigning at least the portion of the available FDD uplink identified for a TDD operation corresponding to the at least one TDD carrier.

2. The system according to claim 1, wherein the available FDD uplink identified corresponds to a half-duplex FDD mode of operation.

3. The system according to claim 1, wherein the operations further comprise receiving uplink control information, from a user device within the coverage area, via a TDD uplink corresponding to the at least one TDD carrier, wherein the TDD uplink utilizes at least the portion of the available FDD uplink.

4. The system according to claim 3, wherein the TDD uplink corresponds to a primary carrier.

5. The system according to claim 1, wherein the operations further comprise receiving a feedback message, from a user device within the coverage area, via a TDD uplink corresponding to the at least one TDD carrier, wherein the TDD uplink utilizes at least the portion of the available FDD uplink.

6. The system according to claim 5, wherein the TDD uplink corresponds to a secondary carrier.

7. The system according to claim 1, wherein the available FDD uplink identified corresponds to LTE band 1.

8. The system according to claim 1, wherein the available FDD uplink identified corresponds to a frequency band of 1900 MHz.

9. A method for utilizing unused frequency division duplex (FDD) uplink for time division duplex (TDD) operation in a wireless telecommunication network, the method comprising:
identifying at least a portion of an available FDD uplink corresponding to an FDD carrier and a wireless telecommunication network associated with a coverage area;
assigning at least the portion of the available FDD uplink identified for a TDD uplink; and
receiving, via the TDD uplink utilizing at least the portion of the available FDD uplink, a transmission from a user device within the coverage area.

10. The method according to claim 9, further comprising:
identifying a second portion of the available FDD uplink; and
assigning the second portion of the available FDD uplink identified for a TDD downlink.

11. The method according to claim 10, further comprising transmitting the TDD downlink assigned the second portion of the available FDD uplink to the user device.

12. The method according to claim 10, wherein both the TDD uplink utilizing at least the portion of the available FDD uplink and the TDD downlink assigned the second portion of the available FDD uplink correspond to a TDD carrier.

13. The method according to claim 12, wherein the TDD carrier is a secondary carrier of the user device.

14. The method according to claim 9, wherein the transmission, from the user device received via the TDD uplink utilizing at least the portion of the available FDD uplink, comprises channel state information, and wherein the user device is configured for FDD and TDD carrier aggregation, and wherein the wireless telecommunication network provides a 5G network.

15. A method for utilizing unused frequency division duplex (FDD) uplink for time division duplex (TDD) operation in a wireless telecommunication network, the method comprising:
identifying at least a portion of an available FDD uplink corresponding to an FDD carrier and a wireless telecommunication network associated with a coverage area;
assigning at least the portion of the available FDD uplink identified for a TDD downlink; and
transmitting the TDD downlink assigned at least the portion of the available FDD uplink to a user device within the coverage area.

16. The method of claim 15, further comprising allocating one or more resource elements to carry downlink information, via the TDD downlink assigned at least the portion of the available FDD uplink, to the user device.

17. The method of claim 15, further comprising:
assigning a second portion of the available FDD uplink identified for a TDD uplink; and
receiving, via the TDD uplink utilizing the second portion of the available FDD uplink, a transmission from the user device within the coverage area.

18. The method of claim 15, further comprising transmitting scheduling information to the user device via the TDD downlink assigned at least the portion of the available FDD uplink.

19. The method of claim 15, wherein the available FDD uplink identified corresponds to a frequency band of 1900 MHz.

20. The method of claim 15, wherein a TDD carrier, associated with the TDD downlink assigned at least the portion of the available FDD uplink, is a primary carrier of the user device.
